(19) United States
(12) Patent Application Publication
(10) Pub. No.: US 2023/0014601 A1
(43) Pub. Date: Jan. 19, 2023

(54) MULTI-SENSOR OCCLUSION-AWARE TRACKING OF OBJECTS IN TRAFFIC MONITORING SYSTEMS AND METHODS

(71) Applicant: FLIR Systems Trading Belgium BVBA, Meer (BE)

(72) Inventor: Koen Janssens, Aaigem (BE)

(21) Appl. No.: 17/948,124

(22) Filed: Sep. 19, 2022

Related U.S. Application Data
(63) Continuation of application No. PCT/US2021/023324, filed on Mar. 19, 2021.
(60) Provisional application No. 62/994,709, filed on Mar. 25, 2020.

(51) Int. Cl. G06V 20/54; G06T 7/277; G06T 7/70; G06T 17/00; G06V 10/25; G06V 10/74; G06V 10/764; G06V 10/82; G01S 13/06; G01J 5/48

(52) U.S. Cl. CPC G06V 20/54; G06T 7/277; G06T 7/70; G06T 17/00; G06V 10/25; G06V 10/761; G06V 10/764; G06V 10/82; G01S 13/06; G01J 5/48; G06V 2201/07; G06T 2207/10016; G06T 2207/20081

(57) ABSTRACT

Systems and methods for tracking objects though a traffic control system include a plurality of sensors configured to capture data associated with a traffic location, and a logic device configured to detect one or more objects in the captured data, determine an object location within the captured data, transform each object location to world coordinates associated with one of the plurality of sensors; and track each object location using the world coordinates using prediction and occlusion-based processes. The plurality of sensors may include a visual image sensor, a thermal image sensor, a radar sensor, and/or another sensor. An object localization process includes a trained deep learning process configured to receive captured data from one of the sensors and determine a bounding box surrounding the detected object and output a classification of the detected object. The tracked objects are further transformed to three-dimensional objects in the world coordinates.

### CROSS REFERENCE TO RELATED APPLICATIONS

This application is a continuation of International Patent Application No. PCT/US2021/023324 filed Mar. 19, 2021 and entitled “MULTI-SENSOR OCCLUSION-AWARE TRACKING OF OBJECTS IN TRAFFIC MONITORING SYSTEMS AND METHODS,” which claims the benefit of and priority to U.S. Provisional Patent Application No. 62/994,709 filed Mar. 25, 2020 and entitled “MULTI-SENSOR OCCLUSION-AWARE TRACKING OF OBJECTS IN TRAFFIC MONITORING SYSTEMS AND METHODS,” all of which are incorporated herein by reference in their entirety.

### TECHNICAL FIELD

The present application relates generally to traffic infrastructure systems and, more particularly for example, to systems and methods for three-dimensional tracking of objects in a traffic scene.

### BACKGROUND

Traffic control systems use sensors to detect vehicles and traffic to help mitigate congestion and improve safety. These sensors range in capabilities from the ability to simply detect vehicles in closed systems (e.g., provide a simple contact closure to a traffic controller) to those that are able to classify (e.g., distinguish between bikes, cars, trucks, etc.) and monitor the flows of vehicles and other objects (e.g., pedestrians, animals).

Within a traffic control system, a traffic signal controller may be used to manipulate the various phases of traffic signal at an intersection and/or along a roadway to affect traffic signalization. These traffic control systems are typically positioned adjacent to the intersection/roadway they control (e.g., disposed upon a traffic signal pole). Traffic control systems generally comprise an enclosure constructed from metal or plastic to house electronic equipment such as a sensor (e.g., an infrared imaging camera or other device), communications components and control components to provide instructions to traffic signals or other traffic control/monitoring devices.

The operation of the traffic signal may be adaptive, responsive, pre-timed, fully-actuated, or semi-actuated depending upon the hardware available at the intersection and the amount of automation desired by the operator (e.g., a municipality). For instance, cameras, loop detectors, or radar may be used to detect the presence, location and/or movement of one or more vehicles. For example, video tracking methods may be used to identify and track objects that are visible in a series of captured images. In response to a vehicle being detected, a traffic signal controller may alter the timing of the traffic signal cycle, for example, to shorten a red light to allow a waiting vehicle to traverse the intersection without waiting for a full phase to elapse or to extend a green phase if it determines an above-average volume of traffic is present and the queue needs additional time to clear.

One drawback of conventional systems is that the systems are limited to tracking objects that are visible in the captured sensor data. For example, a large truck in an intersection may block the view of one or more smaller vehicles from a camera used to monitor traffic. Motion detection algorithms, which track objects across a series of captured images, may not accurately track objects that are blocked from view of the camera. In view of the foregoing, there is a continued need for improved traffic control systems and methods that more accurately detect and monitor traffic.

### SUMMARY

Improved traffic infrastructure systems and methods are disclosed herein. In various embodiments, systems and methods for tracking objects though a traffic control system include a plurality of sensors configured to capture data associated with a traffic location, and a logic device configured to detect one or more objects in the captured data, determine an object location within the captured data, transform each object location to world coordinates associated with one of the plurality of sensors; and track each object location using the world coordinates using prediction and occlusion-based processes. The plurality of sensors may include a visual image sensor, a thermal image sensor, a radar sensor, and/or another sensor. An object localization process includes a trained deep learning process configured to receive captured data from one of the sensors and determine a bounding box surrounding the detected object and output a classification of the detected object. The tracked objects are further transformed to three-dimensional objects in the world coordinates.

The scope of the present disclosure is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

Aspects of the disclosure and their advantages can be better understood with reference to the following drawings and the detailed description that follows. It should be appreciated that like reference numerals are used to identify like elements illustrated in one or more of the figures, where showings therein are for purposes of illustrating embodiments of the present disclosure and not for purposes of limiting the same. The components in the drawings are not necessarily to scale, emphasis instead being placed upon clearly illustrating the principles of the present disclosure.

FIG. 1 is a block diagram illustrating an operation of an object tracking system, in accordance with one or more embodiments.

FIG. 2 illustrates an example object localization process through deep learning, in accordance with one or more embodiments.

FIG. 3 is an example thermal image and CNN object localization results, in accordance with one or more embodiments.

FIG. 4 illustrates example embodiments for transforming sensor data into world coordinates, in accordance with one or more embodiments.

FIG. 5 illustrates an example distance matching algorithm, in accordance with one or more embodiments.

FIG. 6 illustrates an embodiment of objection location prediction using Kalman filtering, in accordance with one or more embodiments.

FIG. 7 illustrates examples of occlusion and prediction handling, in accordance with one or more embodiments.

FIG. 8 illustrates example transformations of bounding boxes into three-dimensional images, in accordance with one or more embodiments.

FIG. 9 is an example image from a tracking system working with a thermal image sensor, in accordance with one or more embodiments.

FIG. 10 is an example image showing the location of objects tracked by the tracking system, indicating their ground plane in the world coordinate system and their associated speed, in accordance with one or more embodiments.

FIG. 11 illustrates an example intelligent transportation system, in accordance with one or more embodiments.

### DETAILED DESCRIPTION

The present disclosure illustrates traffic infrastructure systems and methods with improved object detection and tracking. In various embodiments, a traffic infrastructure system includes an image capture component configured with an image sensor (e.g., a visual image sensor or a thermal image sensor) to capture video or images of a traffic scene and/or one or more other sensors. The system is configured with a trained embedded deep learning-based object detector for each sensor, allowing the traffic infrastructure system to acquire the locations of all the objects in the image. These objects may include different types of vehicles, pedestrians, cyclists and/or other objects. The deep learning object detector may provide a bounding box around each object, defined in image coordinates, and these image coordinates are transformed to Cartesian camera-centered world coordinates using each of the sensors' intrinsic parameters and the device's extrinsic parameters.

Other sensor data may be transformed in a similar manner. For example, the traffic infrastructure system may include a radar sensor configured to detect objects by transmitting radio waves and receiving reflections. The radar sensor can acquire the distance and angle from the object to the sensor which is defined in polar coordinates. These polar coordinates can also be transformed to Cartesian camera-centered world coordinates.

In various embodiments, the traffic infrastructure system transforms the coordinates of sensed objects to the camera-centered world coordinate system, which allows the tracking system to be abstracted from whichever sensor is being used. Physically-based logic is then used in the tracking system and objects are modeled in a traffic scene based on real-life fundamentals. Various objects from the different types of sensors can be matched together based on distances in the camera-centered world coordinate system. The tracking system combines the various sensor acquired object coordinates to track the objects.

After a new object is acquired and has been tracked for a short distance, the tracking system may initiate a Kalman Filter (e.g., an unscented Kalman Filter) to start predicting and filtering out expected noise from each sensor. The Kalman Filter models the location, speed and heading of tracked objects. This also allows the traffic infrastructure system to keep predicting the trajectory of objects while the acquisition sensors have temporarily lost sight of the object. This can happen due to failures in the sensors, failure in the object localization algorithms or occlusions of objects, for example.

Next, the traffic infrastructure system transforms the locations, which are two-dimensional points in the coordinate system, to fully 3D objects. The volume of the object and the ground plane of the object is estimated. This can be estimated, for example, because the trajectory and heading of the object is known and the angle as seen from the devices standpoint. The tracking system provides the 3D objects in the world coordinates system to an application that uses object location information, such as vehicle presence detection at intersections, crossing pedestrian detection, counting and classification of vehicles, and other applications. The use of the 3D objects in the world coordinate system also simplifies those applications greatly because they don't have to include occlusion handling mechanisms or noise reduction mechanism themselves.

In various embodiments disclosed herein, tracking systems are described that are inherently capable of handling multiple sensor inputs where the abstraction from a specific sensor can be transformed to world coordinates. These tracking systems are capable of predicting and handling occlusions to keep track of the location of objects even if all sensors lost sight of the object. These tracking systems are also able to estimate the real object volume in the world (e.g., width, height, length).

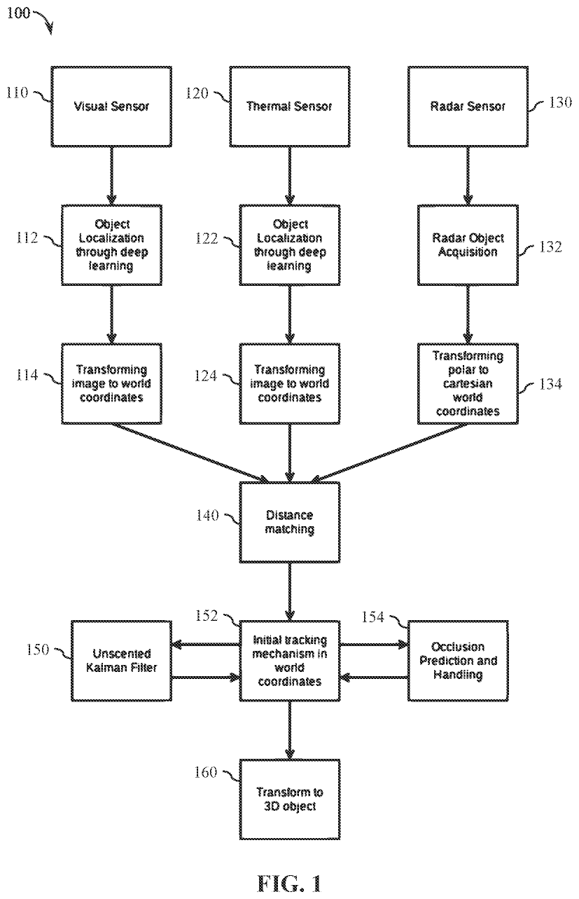

Referring to FIG. 1, an operation of a tracking system will be described in accordance with one or more embodiments. A tracking system 100 may be implemented as part of a traffic infrastructure system or other system with fixed sensors that are used to track vehicles and other objects through an area. The tracking system 100 includes a plurality of sensors, such as a visual sensor 110, a thermal sensor 120 and a radar sensor 130. Other sensors and sensor combinations may also be used. The visual sensor 110 may include an image capture device (e.g., a camera) configured to capture visible light images of a scene. The captured images are provided to an object localization algorithm 112, which may include a deep learning model trained to identify one or more objects within a captured image. The object location within the captured images are transformed to world coordinators, such as the world coordinates of a sensor through a transformation algorithm 114.

The thermal sensor 120 may include a thermal image capture device (e.g., a thermal camera) configured to capture thermal images of the scene. The captured thermal images are provided to an object localization algorithm 122, which may include a deep learning model trained to identify one or more objects within a captured thermal image. The object location within the captured thermal images are transformed to world coordinators through a transformation algorithm 124.

The radar sensor 130 may include a transmitter configured to produce electromagnetic pulses and a receiver configured to receive reflections of the electromagnetic pulses off of objects in the location of the scene. The captured radar data is provided to an object localization algorithm 132, which may include a background learning algorithm that detects movement in the captured data and/or a deep learning model trained to identify one or more objects within the radar data. The object location within the captured radar data are transformed to world coordinators through a transformation algorithm 134.

World coordinates of the objects detected by the various sensors 110, 120 and 130 are provided to a distance matching algorithm 140. The distance matching algorithm 140 matches objects detected by one or more sensors based on location and provide the synthesized object information to an object tracking system 152 that is configured to track detected objects using world coordinates. A Kalman Filter 150 (e.g., an unscented Kalman filter) is used to provide a prediction of location based on historic data and previous three-dimensional location of the object. An occlusion prediction and handling algorithm 154 may also be used to track objects that are occluded from detection of one or more sensors. Finally, the tracked objects are transformed to three-dimensional object representations (e.g., through a 3D bounding box having a length, width and height in the world coordinates) through a 3D object transformation process 160.

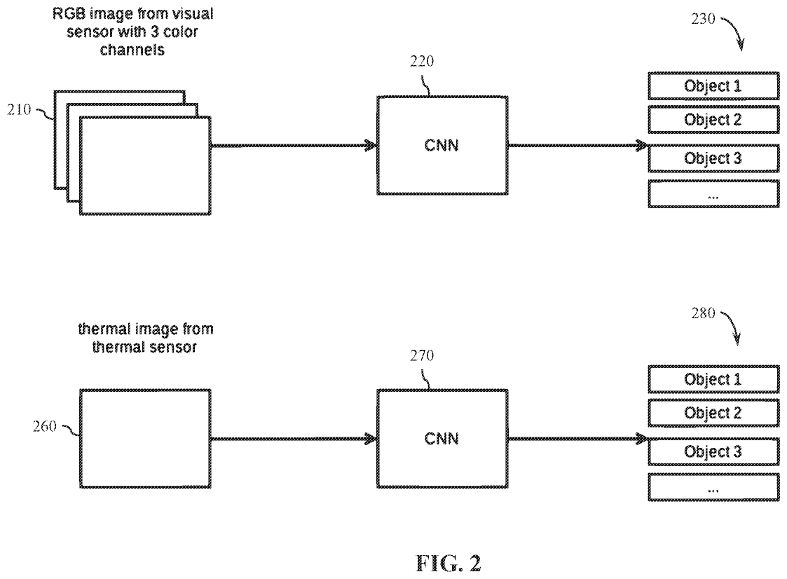

Referring to FIG. 2, embodiments of object localization through deep learning will now be described. Convolutional Neural Networks (CNNs) can be used to acquire the locations of objects in an image. The input of a CNN is the image and all its pixels, such as an RGB image 210 captured from a visible light sensor or a thermal image 260 captured from an infrared sensor. The output of the CNN (e.g., CNN 220 or CNN 270) is a list of bounding boxes 230 and 280 associated with each detected object, including the class type (e.g., car, truck, person, cyclist, . . . ) and a confidence level of how accurate the CNN sees the particular object of that class. The CNN is trained to be able to recognize the different objects to be detected for the particular environment and may be implemented using a variety of architectures that are capable of outputting bounding boxes for the detected objects.

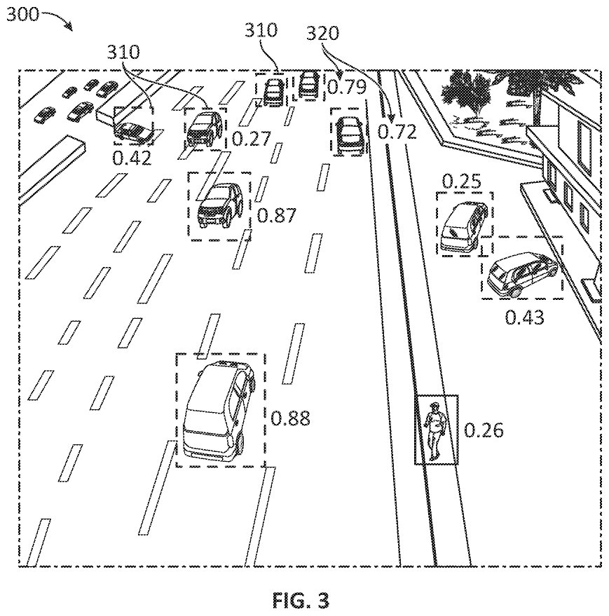

FIG. 3, illustrates an example operation of a CNN that is able to detect the locations of all vehicles in the scene. A thermal image 300 of a traffic location is processed through a trained CNN to identify vehicles in the thermal image 300. Each detected vehicle is identified by a bounding box (e.g., bounding boxes 310). The number next to each bounding box represents the confidence 320 associated with that bounding box and the color and/or style (e.g., solid lines, dashed lines, dotted lines) of the bounding boxes can be selected to represent different class types.

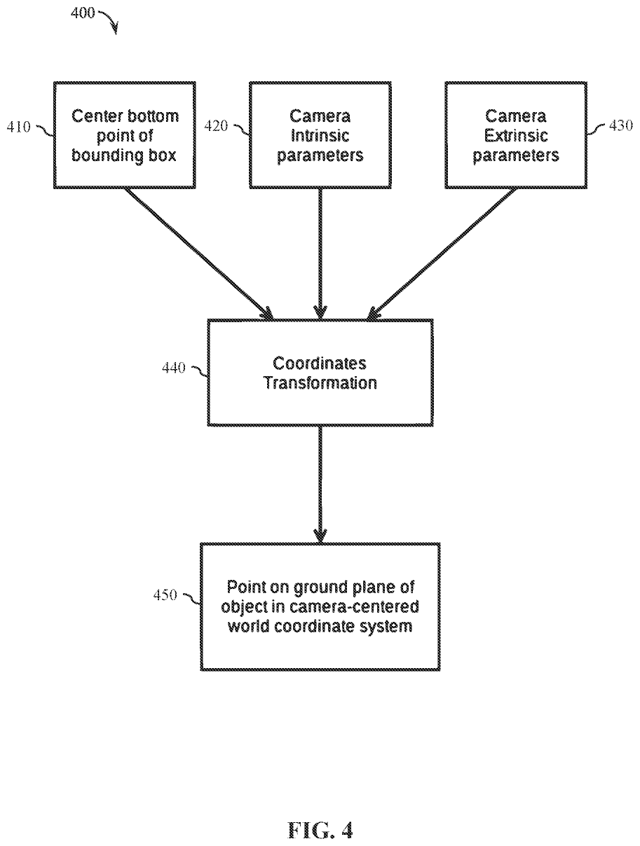

Referring to FIG. 4, embodiments for transforming sensor data (e.g., bounding box sizes and locations) into world coordinates will now be described. A process 400 combines inputs including image location of bounding boxes 410 (e.g., center bottom point of bounding box), camera intrinsic parameters 420 and camera extrinsic parameters 430. The inputs are provided to a coordinates transformation process 440, which outputs the object location (e.g., point on ground plane of object) in the camera centered world coordinate system 450. In some embodiments, the image coordinates are transformed using a pinhole camera model that describes a relationship between the projection onto the image plane and the three-dimensional space in the world.

The camera intrinsic parameters 420 may include information describing the configuration of the camera, such as a focal length, sensor format and principal point. The extrinsic parameters may include camera height, tilt angle and pan angle. In various embodiments, the tracking system tracks a single point location for each object (e.g., the center bottom point of the bounding box). It is observed that this point is likely to be the back or front of an object that is located on the ground plane.

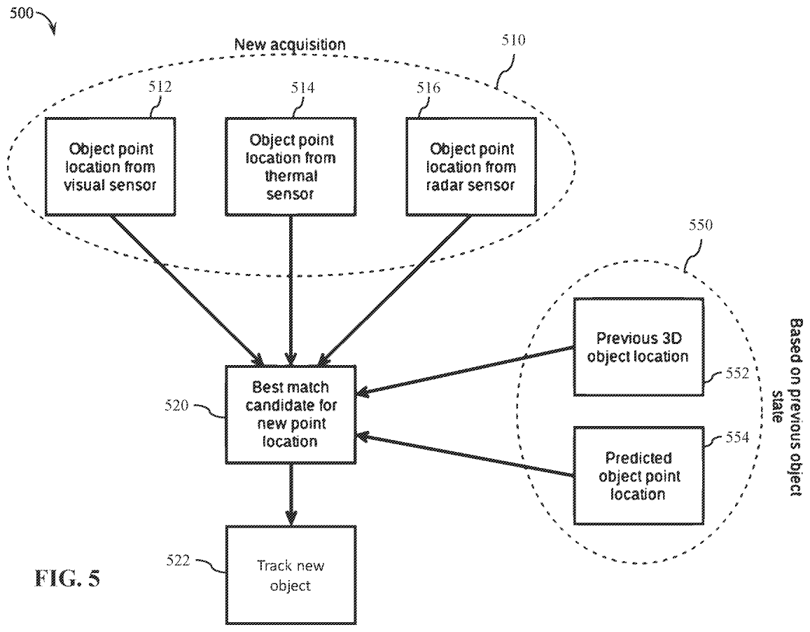

Referring to FIG. 5, an example distance matching algorithm will now be described in accordance with one or more embodiments. The distance matching algorithm 500 combines newly acquired sensor data 510 with previous object tracking information 550 to determine the best match candidate for an object's new point location, through a best match process 520. The newly acquired sensor data 510 may include object point location data from a visual sensor 512, object point location data from a thermal sensor 514, object point location from a radar sensor 516, and/or object point location data from another sensor type. The data is input to the best match process 520. The previous object tracking information 550 may include previous 3D object location 552 including data defining the object's location in three-dimensional space, and a predicted object location 554.

In some embodiments, the tracking system decides between multiple candidates for locations of objects from the multiple sensors (e.g., sensors 512, 514 and 516), along with the predicted locations 554 based on historic data (e.g., by Kalman Filter) and previous 3D object location 552 (e.g., ground plane of object and volume). The system determines the best candidate for a new updated location of the object, based on the available data. The best candidate is decided based on a combination of real world distances of the new acquired location and the predicted location, also taking into account the confidence values of the candidate locations. If a new candidate location does not fit the criteria, the tracking system will start tracking this candidate location as a new object 522. It is also considered that based on the physical volume of the already tracked 3D objects, it should not be possible for objects to overlap in the real world.

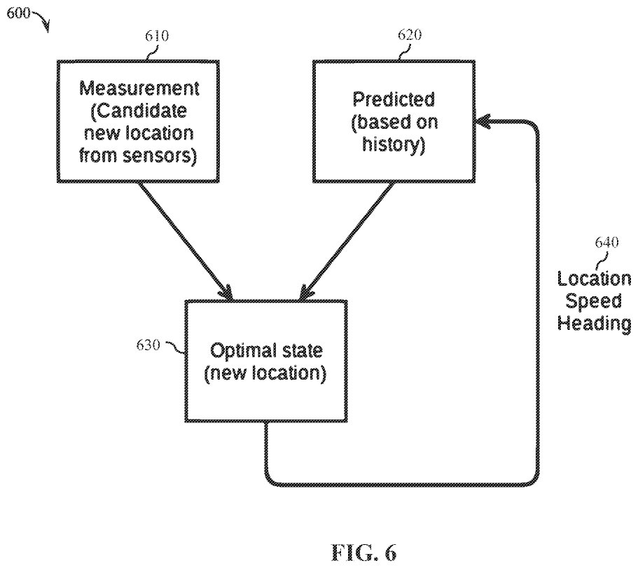

Referring to FIG. 6, an embodiment of object location prediction using Kalman filtering will now be described in accordance with one or more embodiments. The process 600 takes as input the candidate new location of the object which is called “Measurement”, as represented by Measurement 610. The process calculates the optimal state 630 (e.g., the new location) based on the measurement 610 and the predicted state 620, which is based on historical data. The predicted state 620 is calculated based on the last optimal state and by taking into account the speed and heading of the object 640. The optimal state 630 is based on a weighting factor between the measurement 610 and the predicted state 620. This weighting factor depends on the stability of the previous received measurements, the confidence associated with the new measurement and the expected noise from the sensors.

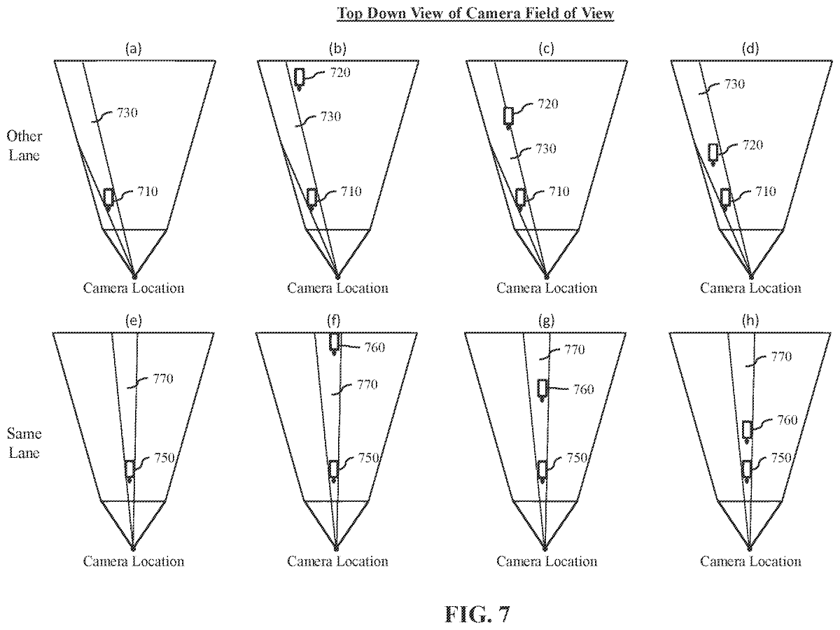

Embodiments of the occlusion and prediction handling will now be described with reference to FIG. 7. The tracking system knows the location of 3D objects in the world, including an estimated height of the object. If another object comes into the scene, it can be predicted when that object will be occluded by another already present object. Based on the angle of the camera the potential occlusion area can be calculated of the already present object. Another object can enter that occlusion area if the distance is further away from the camera than the other object and depending on the height of that object, together with the camera parameters, it can be determined if the new entering object will be occluded.

If an occlusion is likely, the particular object potentially will have no new candidates from all the sensors. The traffic monitoring system may handle occlusion, for example, by using the predictions from the Kalman Filter. If the first object moves away, it is expected that the object that was occluded will become visible again and the tracking system will expect new candidates from the sensors to keep this object ‘alive’.

FIG. 7 illustrates two examples of object tracking with occlusion. In a first example, illustrated by images (a), (b), (c) and (d), a first object 710 (e.g. vehicle) is standing still in the camera field of view. The camera location is at the bottom of each image and the image indicates the field of view of the camera. The first object 710 is illustrated as a bounding box with a point at the bottom-middle of the bounding box for tracking the location on the image. The area behind the bounding box relative to the camera location is a potential occlusion area 730. If another object enters the scene, such as second object 720, it is possible for it to enter this occlusion area 730 (as shown in image sequence (a) through (d)). Depending on the height of the first object, it can be calculated exactly when this object will be occluded, and even how much it will be occluded.

In the second example (illustrated in image sequence (e) through (h)), the first object 750 and second object 760 are both driving in the same lane. In this case, the occlusion area 770 depends at least in part on the height of the first object 750. Taking this into account, it can be calculated how close the second object 760 needs to get behind the first object 750 to be occluded. In this case, the second object 760 might not be visible anymore in all the sensors but the tracking system knows it is still there behind the first vehicle 750 as long no sensor detects him again.

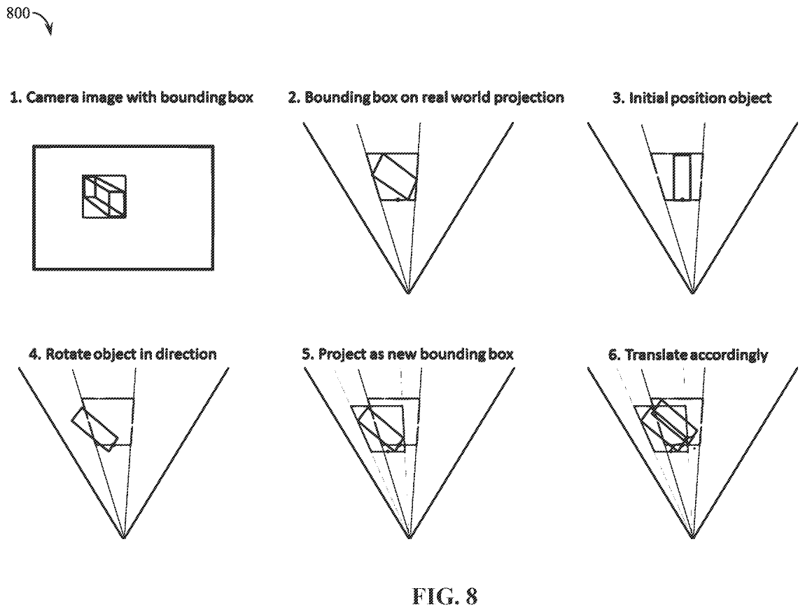

Referring to FIG. 8, an example process 800 for transforming bounding boxes into three-dimensional images will now be described, in accordance with one or more embodiments. The camera receives an image with an object, which is fed into a trained CNN of the tracking system to determine an associated bounding box (step 1 in the example). As illustrated in step 2 of the example, the tracking system has identified a bounding box and a point of the object on the ground closest to the camera (original center bottom point of the bounding box). This point is tracked in the world coordinate system. By tracking this point, the trajectory and heading of the object is known to the tracking system. In various embodiments, this point will not exactly represent the center point of the object itself, depending on the angle of the trajectory compared the camera position and other factors. The goal in various embodiments is to estimate the exact ground plane of the object and estimate its length.

In one embodiment, the first step is to define the initial size of the object, and therefore ground plane of the object, in the world where the original tracked point is the center bottom point of the object. bounding box (step 3 in the example) The initial size of the object is chosen based on the class type of the object originally determined by the CNNs on the image sensors or by the radar sensor. After that the ground plane of the object is rotated based on the previous trajectory and heading of the object. (step 4 in the example). By projecting this ground plane of the object back to the original image sensor, this rotated ground plane will correspond to a new projected center bottom point of the projected bounding box. (step 5 in the example: new bounding box and dot). The translation is calculated between the original point and the newly projected point. This translation is now done in the opposite way to compensate for the angle of view as seen from the camera position. This will then correspond with the real ground plane of the object (step 6 in the example).

The width and height of the object is determined based on the class type determined by the CNNs on the image sensors and the radar sensor. However, the real length of the object can be estimated more accurately if we have input from the image sensors. The original bounding box determined by the CNN can be used to calculate the real length. Projecting the 3D object back to the image plane and comparing this with the original bounding box, the length of the 3D object can be extended or shortened accordingly.

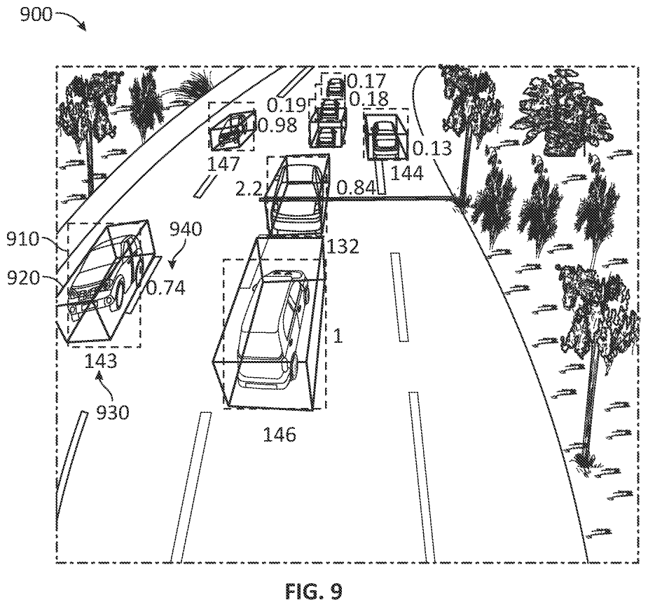

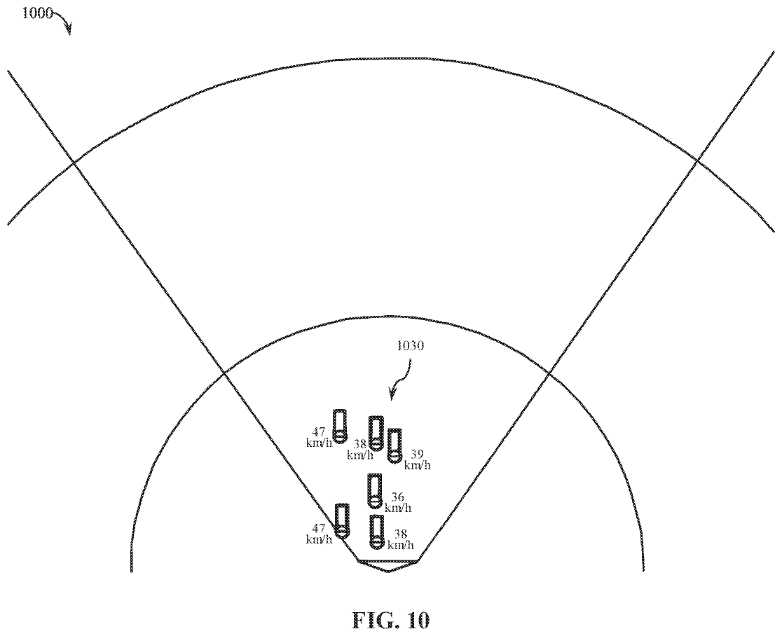

An example image 900 from a tracking system working with a thermal image sensor is illustrated in FIG. 9. The 2D bounding boxes (as indicated by black rectangles, such as bounding box 910) show the output from the CNN running on the thermal image, which may include a confidence factor 940. The 3D bounding boxes (as indicated by white 3D wireframe boxes, such as 3D bounding box 920) shows the estimated object volume by the tracking system, as converted back to the original image plane, and may include additional displayed information, such as an object identifier 930. This image shows the camera-centered world coordinate system with the camera position in the center bottom location. Referring to FIG. 10, an image 1000 shows the location of all objects 1030 tracked by the tracking system indicating their ground plane in the world coordinate system and their associated speed. The images may present difference views, display additional and/or other combinations of information and views in accordance with a system configuration.

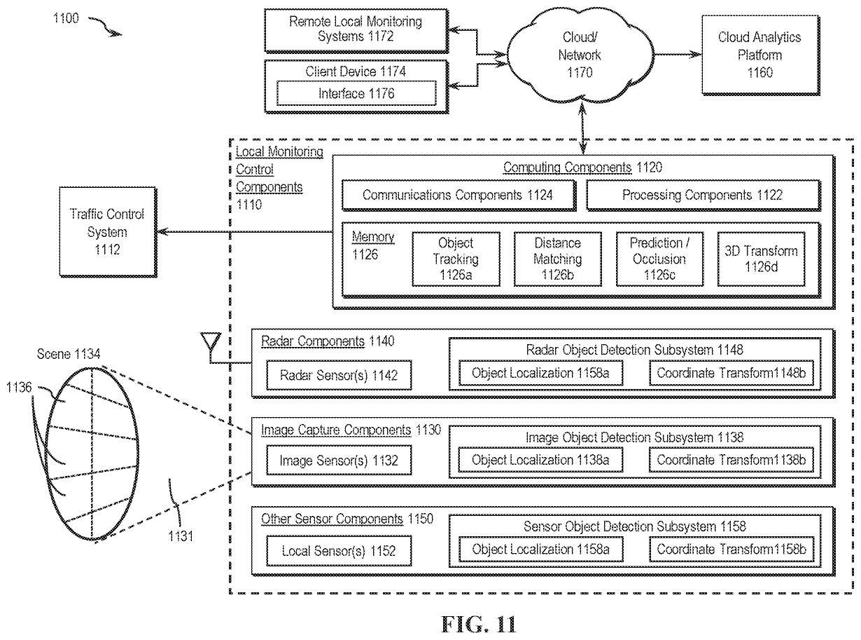

Referring to FIG. 11, an example intelligent transportation system implementing various aspects of the present disclosure will now be described in accordance with one or more embodiments. In some embodiments, an intelligent transportation system (ITS) 1100 includes local monitoring and control components 1110 for monitoring a traffic region and/or controlling a traffic control system 1112 associated with the traffic region (e.g., a system for controlling a traffic light at an intersection). The local monitoring and control components 1110 may be implemented in one or more devices associated with a monitored traffic area, and may include various processing and sensing components, including computing components 1120, image capture components 1130, radar components 1140, and/or other sensor components 1150.

The image capture components 1130 are configured to capture images of a field of view 1131 of a traffic location (e.g., scene 1134 depicting a monitored traffic region). The image capture components 1130 may include infrared imaging (e.g., thermal imaging), visible spectrum imaging, and/or other imaging components. In some embodiments, the image capture components 1130 include an image object detection subsystem 1138 configured to process captured images in real-time to identify desired objects such as vehicles, bicycles, pedestrians and/or other objects. In some embodiments, the image object detection subsystem 1138 can be configured through a web browser interface and/or software which is installed on a client device (e.g., remote client device 1174 with interface 1176 and/or another system communicably coupled to the image capture components 1130). The configuration may include defined detection zones 1136 within the scene 1134. When an object passes into a detection zone 1136, the image object detection subsystem 1138 detects and classifies the object. In a traffic monitoring system, the system may be configured to determine if an object is a pedestrian, bicycle or vehicle. If the object is a vehicle or other object of interest, further analysis may be performed on the object to determine a further classification of the object (e.g., vehicle type) based on shape, height, width, thermal properties and/or other detected characteristics.

In various embodiments, the image capture components 1130 include one or more image sensors 1132, which may include visible light, infrared, or other imaging sensors. The image object detection subsystem 1138 includes at least one object localization module 1138a and at least one coordinate transformation module 1138b. The object localization module 1138a is configured to detect an object and define a bounding box around the object. In some embodiments, the object localization module 1138a includes a trained neural network configured to output an identification of detected objects and associated bounding boxes, a classification for each detected object, and a confidence level for classification. The coordinate transformation module 1138b transforms the image coordinates of each bounding box to real-world coordinate associated with the imaging device. In some embodiments, the image capture components include multiple cameras (e.g., a visible light camera and a thermal imaging camera) and corresponding object localization and coordinate transform modules.

In various embodiments, the radar components 1140 include one or more radar sensors 1142 for generating radar data associated with all or part of the scene 1134. The radar components 1140 may include a radar transmitter, radar receiver, antenna and other components of a radar system. The radar components 1140 further include a radar object detection system 1148 configured to process the radar data for use by other components of the traffic control system. In various embodiments, the radar object detection subsystem 1148 includes at least one object localization module 1148a and at least one coordinate transformation module 1148b. The object localization module 1148a is configured to detect objects in the radar data and identify a location of the object with reference to the radar receiver. In some embodiments, the object localization module 1148a includes a trained neural network configured to output an identification of detected objects and associated location information, a classification for each detected object and/or object information (e.g., size of an object), and a confidence level for classification. The coordinate transformation module 1148b transforms the radar data to real-world coordinates associated with the image capture device (or another sensor system)

In various embodiments, the local monitoring and control components 1110 further include other sensor components, which may include feedback from other types of traffic sensors (e.g., a roadway loop sensor) and/or object sensors, which may include wireless systems, sonar systems, LiDAR systems, and/or other sensors and sensor systems. The other sensor components 1150 include local sensors 1152 for sensing traffic-related phenomena and generating associated data, and associated sensor object detection systems 1158, which includes object localization module 1158a, which may include a neural network configured to detect objects in the sensor data and output location information (e.g., a bounding box around a detected object), and a coordinate transformation module 1158b to transform the sensor data location to real-world coordinates associated with the image capture device (or other sensor system).

In some embodiments, the various sensor systems 1130, 1140 and 1150 are communicably coupled to the computing components 1120 and/or the traffic control system 1112 (such as an intersection controller). The computing components 1120 are configured to provide additional processing and facilitate communications between various components of the intelligent traffic system 1100. The computing components 1120 may include processing components 1122, communication components 1124 and a memory 1126, which may include program instructions for execution by the processing components 1122. For example, the computing components 1120 may be configured to process data received from the image capture components 1130, radar components 1140, and other sensing components 1150. The computing components 1120 may be configured to communicate with a cloud analytics platform 1160 or another networked server or system (e.g., remote local monitoring systems 1172) to transmit local data for further processing. The computing components 1120 may be further configured to receive processed traffic data associated with the scene 1134, traffic control system 1112, and/or other traffic control systems and local monitoring systems in the region. The computing components 1120 may be further configured to generate and/or receive traffic control signals for controlling the traffic control system 1112.

The computing components 1120 and other local monitoring and control components 1110 may be configured to combine local detection of pedestrians, cyclists, vehicles and other objects for input to the traffic control system 1112 with data collection that can be sent in real-time to a remote processing system (e.g., the cloud 1170) for analysis and integration into larger system operations.

In various embodiments, the memory 1126 stores program instructions to cause the processing components 1122 to perform the processes disclosed herein with reference to FIGS. 1-10. For example, the memory 1126 may include (i) an object tracking module 1126a configured to track objects through the real world space defined by one of the system components, (ii) a distance matching module 1126b configured to match sensed objects with tracked object data and/or identify a new object to track, (iii) prediction and occlusion modules 1126c configured to predict the location of tracked objects, including objects occluded from detection by a sensor, and (iv) a 3D transformation module configured to define a 3D bounding box or other 3D description of each object in the real world space.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein. Embodiments described above illustrate but do not limit the invention. It should also be understood that numerous modifications and variations are possible in accordance with the principles of the invention. Accordingly, the scope of the invention is defined only by the following claims.

What is claimed:

1. A system comprising:
a first image sensor configured to capture a stream of images of scene from an associated real-world position;
an object localization system configured to identify an object in the captured image and define an associated object location in the image;
a coordinate transformation system configured to transform the associated object location in the image to real-world coordinates associated with the real-world position of the first image sensor;
an object tracking system configured to track detected objects using the real-world coordinates; and
a three-dimensional transformation system configured to define a three-dimensional shape representing the object in the in the real-world coordinates.

2. The system of claim 1, further comprising a radar sensor configured to capture radar data associated with the scene;
a radar object localization system configured to identify an object in the radar data;
a radar coordinate transformation system configured to transform the radar object location to the real-world coordinates associated with the real-world position of the first image sensor; and
a distance matching system configured to synthesize the radar object and first image sensor objects in the real-world coordinates.

3. The system of claim 1, wherein the first image sensor comprises a visible image sensor, and wherein the system further comprises:
a thermal image sensor configured to capture a stream of thermal images of the scene;
a thermal object localization system configured to identify an object in the thermal images;
a second coordinate transformation system configured to transform the thermal image object location to the real-world coordinates associated with the first image sensor; and
a distance matching system configured to synthesize the thermal image object and first image sensor object in the real-world coordinates.

4. The system of claim 1, wherein the object localization system further comprises:
a neural network trained to receive the captured images and output an identification of one or more detected objects, a classification of each detected object, a bounding box substantially surrounding the detected object and/or a confidence level of the classification.

5. The system of claim 1, wherein the real-world coordinates comprise a point on a ground plane of the object in a first image sensor centered real-world coordinate system.

6. The system of claim 1, wherein the object tracking system is configured to measure a new object location from sensors, predict an object location, and determine a location of the object based on the measurement and the prediction.

7. A system comprising:
a plurality of sensors configured to capture data associated with a traffic location;
a logic device configured to:
detect one or more objects in the captured data;
determine an object location within the captured data;
transform each object location to world coordinates associated with one of the plurality of sensors; and
track each object location using the world coordinates.

8. The system of claim 7, wherein the plurality of sensors comprises at least two of a visual image sensor, a thermal image sensor and a radar sensor.

9. The system of claim 7, wherein determine an object location within the captured data comprises an object localization process comprising a trained deep learning process.

10. The system of claim 9, wherein the deep learning process is configured to receive captured data from one of the sensors and determine a bounding box surrounding the detected object.

11. The system of claim 9, wherein the deep learning process is configured to receive captured data from one of the sensors, detect an object in the captured data and output a classification of the detected object including a confidence factor.

12. The system of claim 7, wherein the logic device is further configured to perform a distance matching algorithm comprising synthesizing the detected objects detected in the data captured from the plurality of sensors.

13. The system of claim 7, wherein the logic device is further configured to track each object location using the world coordinates by predicting an object location using a Kalman Filter and predicting and handling occlusion.

14. The system of claim 7, wherein the logic device is further configured to transform the tracked objects to three-dimensional objects in the world coordinates.

15. A method comprising
capturing data associated with a traffic location using a plurality of sensors;
detecting one or more objects in the captured data;
determining an object location within the captured data;
transforming each object location to world coordinates associated with one of the plurality of sensors; and
tracking each object location through the world coordinates.

16. The method of claim 15, wherein the plurality of sensors comprises at least two of a visual image sensor, a thermal image sensor and a radar sensor; and
wherein the method further comprises synthesizing the objects detected in the data captured from the plurality of sensors through a distance matching process.

17. The method of claim 15, wherein determining an object location within the captured data comprises a deep learning process comprising receiving captured data from one of the sensors and determining a bounding box surrounding the detected object.

18. The method of claim 17, wherein the deep learning process further comprises detecting an object in the captured data and outputting a classification of the detected object including a confidence factor.

19. The method of claim 15, further comprising tracking each object location using the world coordinates by predicting an object location using a Kalman Filter and predicting and handling occlusion.

20. The method of claim 15, further comprising transforming the tracked objects to three-dimensional objects in the world coordinates.
